(19) United States
(12) Patent Application Publication
(10) Pub. No.: US 2023/0302397 A1
(43) Pub. Date: Sep. 28, 2023

(54) Dual-Loop Solution-Based Carbon Capture System and Method

(71) Applicant: University of Kentucky Research Foundation, Lexington, KY (US)

(72) Inventors: Kunlei Liu, Lexington, KY (US); Heather Nikolic, Stamping Ground, KY (US); Xin Gao, Lexington, KY (US)

(21) Appl. No.: 18/125,614

(22) Filed: Mar. 23, 2023

Related U.S. Application Data
(60) Provisional application No. 63/323,199, filed on Mar. 24, 2022.

(51) Int. Cl. B01D 53/14; B01D 53/18; B01D 53/62; B01D 53/78; B01D 53/96

(52) U.S. Cl. CPC B01D 53/1406; B01D 53/1425; B01D 53/1475; B01D 53/1493; B01D 53/18; B01D 53/62; B01D 53/78; B01D 53/965; B01D 2252/504; B01D 2252/20421; B01D 2252/103; B01D 2251/604; B01D 2251/306; B01D 2257/504; B01D 2258/0283; B01D 71/36

(57) ABSTRACT

A carbon capture system includes: (a) an absorber having an inorganic solvent carbon dioxide capture section, a water wash section between the organic solvent carbon dioxide capture section and the inorganic solvent carbon dioxide capture section, a flue gas inlet at the organic solvent carbon dioxide capture section and a treated flue gas outlet at the inorganic solvent carbon dioxide capture section, (b) a stripper, (c) a polishing circuit, and (d) a water wash circuit. A related method of carbon capture includes sequentially subjecting the flue gas to (i) organic solvent carbon dioxide capture, (ii) water washing and (iii) inorganic solvent carbon dioxide capture.

### RELATED APPLICATIONS

This document claims priority to U.S. Provisional Patent Application Ser. No. 63/323,199, filed Mar. 24, 2022, which is hereby incorporated by reference in its entirety.

### GOVERNMENT INTEREST

The invention was made with Government support under grant DE-FE0032134 awarded by the Department of Energy National Energy Technology Laboratory. The Government has certain rights in the invention.

### TECHNICAL FIELD

This document relates to a dual loop solution-based carbon capture system and method to lower capital cost by as much as 50% and offset operating cost with negative carbon dioxide (CO₂) emissions and hydrogen (H₂) production, while minimizing amine-based solvent degradation.

### BACKGROUND

The low CO₂ (approximately 4 vol %) and high oxygen (O₂) (approximately 12 vol %) concentrations in natural gas combined cycle (NGCC) flue gas along with desires for very high CO₂ capture efficiency (95+%) at low cost represents a very significant technical challenge.

The carbon capture system and related method of carbon capture, set forth in this document, meet this challenge by use of a dual-loop solution-based approach to carbon capture wherein both organic and inorganic solvents are used in sequence to more efficiently and effectively capture CO₂ from the flue gas. Advantageously, this approach allows the use of a smaller absorber column (thereby reducing capital costs), reduces the cost of CO₂ capture, and potentially offsets operation costs with H₂, O₂ and CO₂ product streams.

### SUMMARY

In accordance with the purposes and benefits set forth herein, a new and improved carbon capture system and method are provided. The carbon capture system comprises, consists of or consists essentially of a primary capture circuit absorber, stripper, heat exchangers, pumps and other balance of plant; a polishing loop circuit, electrochemical regenerator, heat exchangers, pumps and other balance of plant; and a water wash circuit separating the flue gas flow between the two capture circuits. The absorber has an organic solvent carbon dioxide capture section, an inorganic solvent carbon dioxide capture section, a water wash section between the organic solvent carbon dioxide capture section and the inorganic solvent carbon dioxide capture section, a flue gas inlet at the organic solvent carbon dioxide capture section and a treated flue gas outlet at the inorganic solvent carbon dioxide capture section. The absorber may take the form of a single column housing the organic solvent carbon dioxide capture section, the inorganic solvent carbon dioxide capture section, and the water wash section between the organic solvent carbon dioxide capture section and the inorganic solvent carbon dioxide capture section. Alternatively, the absorber may comprise more than one column housing these sections.

The stripper is provided in communication with the organic solvent carbon dioxide capture section. The stripper is adapted to receive carbon dioxide-rich organic solvent from the absorber column and return carbon dioxide-lean organic solvent to the absorber column. The polishing circuit is provided in communication with the inorganic solvent carbon dioxide capture section. The polishing circuit is adapted to release captured carbon dioxide, regenerate the inorganic solvent and return the inorganic solvent to the absorber column. The water washing circuit is provided in communication with the water wash section. The water washing circuit is adapted for removing entrained and aerosol organic solvent and return of wash water to the absorber column.

In at least one of the many possible embodiments of the carbon capture system, the polishing circuit includes an electrochemical cell. That electrochemical cell may include an anode, a cathode and a cation exchange membrane. The cation exchange membrane may be made from a sulfonated tetrafluoroethylene based fluoropolymer copolymer and is adapted for the passage of metal ions such as potassium ions. A hydrogen product stream is generated at the electrochemical cell. The polishing circuit may also include a flash vessel downstream from the electrochemical cell. Carbon dioxide and oxygen are generated at the flash vessel. These may be subsequently processed in a manner known in the art to provide discrete carbon dioxide and oxygen product streams.

The inorganic solvent may be potassium hydroxide (KOH). Another possible inorganic solvent useful in the carbon capture system and method is sodium hydroxide (NaOH). The organic solvent useful in the carbon capture system and method is a primary amine solvent.

More particularly, the primary amine solvent may be about 45 vol % primary amine and about 55 vol % water. In one particularly useful embodiment, the primary amine is a mixture of 1-amino-2-propanol and 2-amino-1-propanol.

In one or more of the many possible embodiments, the carbon capture system further includes structured packing in the organic solvent carbon dioxide capture section and a carbon dioxide-lean organic solvent inlet on a side of the structured packing opposite the flue gas inlet so as to provide countercurrent flow of flue gas and organic solvent across the structured packing. In one or more of the many possible embodiments, the inorganic solvent carbon dioxide capture section of the carbon capture system further includes a plurality of nozzles adapted for generating a fog of inorganic solvent in the inorganic solvent carbon dioxide capture section. This is done to increase the contact surface area between the inorganic solvent and the flue gas in order to improve capture efficiency. Still further, the inorganic solvent carbon dioxide capture section may include a cooling circuit for cooling the flue gas and inorganic solvent in the inorganic solvent carbon dioxide capture section so that the section operates at peak efficiency at all times.

In accordance with an additional aspect, a method of carbon capture from a flue gas, comprises, consists of or consists essentially of sequentially subjecting the flue gas to (a) organic solvent carbon dioxide capture, (b) water washing and (c) inorganic solvent carbon dioxide capture. This may all be done in a single absorber column or multiple columns.

The method may include the step of using potassium hydroxide (KOH) as the inorganic solvent. The method may include spraying the KOH to produce KOH droplets which may have a Sauter mean diameter of less than 50 μm in the absorber column. This is done to increase contact surface area and the efficiency of the carbon capture in the inorganic solvent carbon dioxide capture section.

In one or more of the many possible embodiments, the method may also include the step of using a mixture of a hindered primary amine and water as the organic solvent. Still further, the method may include the step of regenerating the inorganic solvent in a polishing circuit including an electrochemical cell and a flash vessel whereby KHCO₃ and K₂CO₃ recovered from the absorber column are processed to release H₂ at the electrochemical cell, release O₂ and CO₂ at the flash vessel and regenerate KOH for return to the absorber column. The method may also include the step of regenerating the organic solvent in a stripper whereby a carbon dioxide-rich organic solvent from the absorber column is processed in the stripper to release CO₂ and a carbon dioxide-lean organic solvent is returned to the absorber column. In accordance with yet another aspect, the method may include the step of regenerating wash water in a water washing circuit adapted for removing entrained and aerosol organic solvent and returning wash water to the absorber column.

In still other possible embodiments, the method may include the step of cooling the flue gas and inorganic solvent during carbon capture to maintain an operating temperature in the inorganic solvent carbon dioxide capture section allowing for the most efficient capture. Further, the method may include the step of maintaining the absorber column at an operating temperature between about 35° C. and 55° C. during carbon dioxide capture.

In the following description, there are shown and described several embodiments of the novel (a) carbon capture system and (b) related method of carbon capture from a flue gas. As it should be realized, the carbon capture system and related method are capable of other, different embodiments and their several details are capable of modification in various, obvious aspects all without departing from the carbon capture system and method as set forth and described in the following claims. Accordingly, the drawing and descriptions should be regarded as illustrative in nature and not as restrictive.

### BRIEF DESCRIPTION OF THE DRAWING FIGURE

The accompanying drawing FIGURE incorporated herein and forming a part of the specification, illustrates several aspects of the novel carbon capture system and related method of carbon capture and together with the description serve to explain certain principles thereof.

FIG. 1 is a schematic representation of one possible embodiment of the new and improved carbon capture system that uses dual-loop solution-based carbon capture technology.

### DETAILED DESCRIPTION

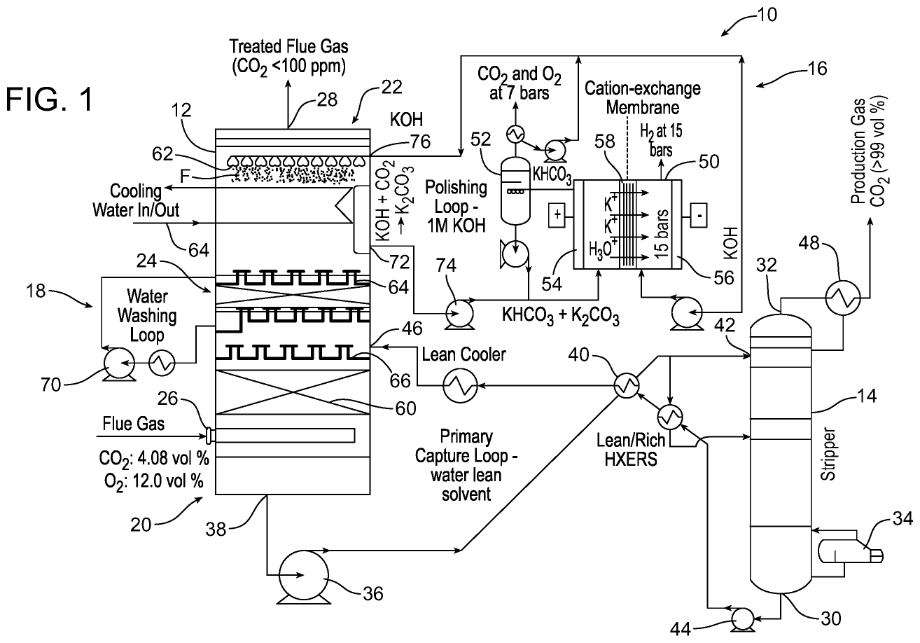

Reference is now made to FIG. 1 which schematically illustrates one possible embodiment of the new and improved carbon capture system 10. As illustrated, that carbon capture system includes a single absorber 12, a stripper 14, a polishing circuit 16 and a water washing circuit 18. The absorber 12 includes an organic solvent carbon dioxide capture section 20, an inorganic solvent carbon dioxide capture section 22, a water wash section 24 between the organic solvent carbon dioxide capture section and the inorganic solvent carbon dioxide capture section, a flue gas inlet 26 at the organic solvent carbon dioxide capture section and a treated flue gas outlet 28 at the inorganic solvent carbon dioxide capture section. In other embodiments, the absorber may comprise multiple absorber columns including or housing these structures.

As should be appreciated, the carbon capture system 10 is a dual-loop solvent-based carbon capture system having (a) an organic solvent loop formed by the organic solvent carbon dioxide capture section 20 in the absorber 12 and the stripper 14 and (b) an inorganic solvent loop formed by the inorganic solvent carbon dioxide capture section 22 and the polishing circuit 16.

The stripper 14, of a type known in the art, includes a CO₂-lean organic solvent outlet 30 at a lower end and a captured CO₂ outlet 32 at an upper end. A reboiler 34 is adapted to add heat to the stripper, releasing the captured CO2 from the solvent. A first pump 36 pumps CO₂-rich organic solvent from the CO₂-rich organic solvent outlet 38, at the bottom of the absorber, though the heat exchanger 40 to the CO₂-rich organic solvent inlet 42 of the stripper 14. A second pump 44 pumps CO₂-lean organic solvent from the CO₂-lean organic solvent outlet 30, at the bottom of the stripper, though the heat exchanger 40 to the CO₂-lean organic solvent inlet 46 of the organic solvent carbon dioxide capture section 20 of the absorber 12. The CO₂ released from the CO₂-rich organic solvent in the stripper 14 flows through the captured CO₂ outlet 32 at an upper end of the stripper through the condenser 48 and the CO₂ gas product is collected for further processing or storage.

The polishing circuit 16 includes an electrochemical cell 50 and a flash vessel 52 downstream from the electrochemical cell. The electrochemical cell 50 includes an anode 54, a cathode 56 and a cation exchange membrane 58. The anode 54 may be made from, for example, dimensionally stable anode (DSA) and the cathode 56 may be made from, for example, Ni-based or Fe-based alloy. The anode 54 and the cathode 56 are connected to a voltage source (not shown). A single cell voltage potential of between about 2 V and about 5 V may be provided across the anode 54 and the cathode 56 during operation of the carbon capture system. The cation exchange membrane 58 may be made, for example, from a sulfonated tetrafluoroethylene based fluoropolymer copolymer that is adapted for the passage of ions from the inorganic solvent.

Various inorganic solvents may be useful in the carbon capture system 10 and the related method. Potassium hydroxide (KOH) is one such inorganic solvent. Sodium hydroxide (NaOH) is another, non-limiting example. Various organic solvents, such as primary amine solvents, may be used in the carbon capture system 10 and method. More particularly, the primary amine solvent may be about 45 vol % primary amine and about 55 vol % water. In one particularly useful embodiment, the primary amine is a mixture of 1-amino-2-propanol and 2-amino-1-propanol. The primary amine solvent may also include tetraethylene glycol dimethyl ether.

In order to aid in more efficient carbon capture, structured packing 60, of a type known in the art, may be included in the organic solvent carbon dioxide capture section 20. In contrast, the inorganic solvent carbon dioxide capture section 22 is open and free of packing. Instead, the inorganic solvent carbon dioxide capture section 22 includes a plurality of nozzles 62 adapted for generating a fog F of inorganic solvent in the inorganic solvent carbon dioxide capture section. More particularly, the nozzles 62 produce inorganic solvent droplets may have a Sauter mean diameter of less than 50 μm in the inorganic solvent carbon dioxide capture section. This achieves a liquid to gas contact surface area that is two to three times higher than that achieved with structured packing, thereby ensuring a fast reaction rate of the inorganic solvent with the CO₂. A bubble cap tray 66, of a type known in the art, collects all of the inorganic solvent at the bottom of the inorganic solvent carbon dioxide capture section 22, while allowing the flue gas to pass upwardly from the water wash section 24 to the inorganic solvent carbon dioxide capture section. A similar bubble cap tray 68 collects all of the wash water at the bottom of the water wash section 24, while allowing the flue gas to pass upwardly from the organic solvent carbon dioxide capture section 20 to the water wash section.

The inorganic solvent carbon dioxide capture section 22 may also include a cooling circuit 64 adapted to maintain the inorganic solvent carbon dioxide capture section 22 within a desired temperature range for more efficient carbon capture by the inorganic solvent. Temperatures within the absorber 12 are generally maintained between about 35° C. and about 55° C.

The carbon capture system 10 described above is useful in a method of carbon capture from a flue gas, including, particularly, natural gas combined cycle flue gas. That method may be broadly described as sequentially subjecting the flue gas to (a) organic solvent carbon dioxide capture, (b) water washing and (c) inorganic solvent carbon dioxide capture. The method may also include using KOH as the organic solvent. More particularly, the method may include spraying the KOH to produce KOH droplets which may have a Sauter mean diameter of less than 50 μm in the inorganic solvent carbon dioxide capture section 22 of the absorber column 12. The method may also include using a hindered primary amine, as the inorganic solvent.

Still further, as illustrated in FIG. 1, the method may include the step of regenerating the inorganic solvent in the polishing circuit 16 including the electrochemical cell 50 and the flash vessel 52. More particularly, KHCO₃ and K₂CO₃ recovered from the absorber 12 are processed to release H₂ at the electrochemical cell 50, release O₂ and CO₂ at the flash vessel 52 and simultaneously regenerate KOH for return to the absorber.

As also illustrated in FIG. 1, the method also includes the step of regenerating the organic solvent in the stripper 14. More particularly, a CO₂-rich organic solvent from the absorber 12 is processed in the stripper 14 to release CO₂ and a CO₂-lean organic solvent is returned to the absorber. In addition and as further illustrated in FIG. 1, the method includes the step of regenerating wash water in a water washing circuit 18 adapted for removing entrained and aerosol organic solvent, and returning wash water to the absorber.

In at least some embodiments, the method also includes the step of cooling the flue gas and inorganic solvent during the carbon capture by the inorganic solvent in order to maintain the absorber at an operating temperature conducive to efficient carbon capture. This includes the maintaining of the absorber at an operating temperature of between about 35° C. and about 55° C.

The carbon capture process using the carbon capture system 10 will now be described in greater detail. Flue gas enters the absorber 12 at the flue gas inlet 26 in direct communication with the organic solvent carbon dioxide capture section 20 below the structured packing 60. Simultaneously, CO₂-lean organic solvent is delivered through the CO₂-lean organic solvent inlet 46 to the organic solvent carbon dioxide capture section 20 above the structured packing 60. This establishes a countercurrent flow of rising flue gas and falling organic solvent at the structured packing which tends to maximize carbon capture and removal of carbon dioxide from the flue gas.

Next, the flue gas passes the bubble cap tray 68 at the bottom of the water wash section 24 and enters the water wash section. Here a pump 70 of the water washing circuit 18 pumps wash water into the water wash section in order to remove entrained and aerosol organic solvent so that the organic solvent is removed from the flue gas rising toward the inorganic solvent carbon dioxide capture section 22. Here it should be noted that liquid accumulating in the water wash is returned back to the organic solvent loop thereby recycling any organic solvent to the system.

The flue gas, now free of any organic solvent, then passes the bubble cap tray 66 at the bottom of the inorganic solvent carbon dioxide capture section 22 and enters the inorganic solvent carbon dioxide capture section. The flue gas then passes upward through the falling fog of inorganic solvent droplets created by the spray nozzles 62. As this occurs, CO₂ remaining in the flue gas is captured by the inorganic solvent. The treated flue gas is then exhausted from the absorber 12 through the treated flue gas outlet 28.

As noted previously, following carbon capture in the organic solvent carbon dioxide capture section 20, the CO₂-rich organic solvent flows through the CO₂-rich organic solvent outlet 38 at the bottom of the absorber 12 and is pumped by the pump 36 to the CO₂-rich organic solvent inlet 42 of the stripper. The CO₂ is stripped from the organic solvent in the stripper so that the CO₂ may be recovered as described above and the now CO₂-lean organic solvent is then exhausted from the stripper through the CO₂-lean organic solvent outlet 30 and returned by the pump 44 to the CO₂-lean organic solvent inlet 46 at the organic solvent carbon dioxide capture section 20 of the absorber.

Following the capture of remaining CO₂ in the flue gas, the CO₂-rich inorganic solvent (KHCO₃ and K₂CO₃ where the solvent is KOH) passes through the CO₂-rich inorganic solvent outlet 72 and is pumped by the pump 74 to the anode side of the electrochemical cell 50. There K⁺ and H₃O⁺ ions pass through the membrane 58 and an H₂ product stream at about 15 bar is generated to offset operating costs of the system 10. The remaining KHCO₃ is then passed to the flash vessel 52 where it is flashed to produce a CO₂ and O₂ product stream at about 7 bars. That stream may be subsequently processed in a manner known in the art to produce separate CO₂ and O₂ product streams. The regenerated KOH is then returned to the inorganic solvent carbon dioxide capture section 22 through the inorganic solvent inlet 76 for spraying through the nozzles 62 to create the fog F.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a spray nozzle”, as used herein, may also refer to, and encompass, a plurality of spray nozzles.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified. Terms of approximation, such as the terms about, substantially, approximately, etc., as used herein, refers to ±10% of the stated numerical value.

Although the carbon capture system and the method of carbon capture from flue gas of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A carbon capture system, comprising:
an absorber having an organic solvent carbon dioxide capture section, an inorganic solvent carbon dioxide capture section, a water wash section between the organic solvent carbon dioxide capture section and the inorganic solvent carbon dioxide capture section, a flue gas inlet at the organic solvent carbon dioxide capture section and a treated flue gas outlet at the inorganic solvent carbon dioxide capture section;
a stripper, in communication with the organic solvent carbon dioxide capture section, adapted to receive carbon dioxide-rich organic solvent from the absorber column and return carbon dioxide-lean organic solvent to the absorber column;
a polishing circuit, in communication with the inorganic solvent carbon dioxide capture section, adapted to release captured carbon dioxide, regenerate the inorganic solvent and return the inorganic solvent to the absorber column; and
a water washing circuit, in communication with the water wash section, adapted to remove organic solvent entrainment and aerosols and return of wash water to the absorber column.

2. The carbon capture system of claim 1, wherein the polishing circuit includes an electrochemical cell.

3. The carbon capture system of claim 2, wherein the polishing circuit further includes a flash vessel downstream from the electrochemical cell.

4. The carbon capture system of claim 3, wherein the electrochemical cell includes an anode, a cathode and a cation exchange membrane.

5. The carbon capture system of claim 4, wherein the cation exchange membrane is made from a sulfonated tetrafluoroethylene based fluoropolymer copolymer and is adapted for the passage of potassium ions.

6. The carbon capture system of claim 5, wherein the inorganic solvent is potassium hydroxide (KOH).

7. The carbon capture system of claim 6, wherein the organic solvent is an amine solvent.

8. The carbon capture system of claim 7, wherein the amine solvent is about 45 vol % primary amine and about 55 vol % water.

9. The carbon capture system of claim 6, further including structured packing in the organic solvent carbon dioxide capture section and a carbon dioxide-lean inorganic solvent inlet on a side of the structured packing opposite the flue gas inlet so as to provide countercurrent flow of flue gas and organic solvent across the structured packing.

10. The carbon capture system of claim 9, wherein the inorganic solvent carbon dioxide capture section further includes a plurality of nozzles adapted for generating a fog of inorganic solvent in the inorganic solvent carbon dioxide capture section.

11. The carbon capture system of claim 10, wherein the inorganic solvent carbon dioxide capture section further includes a cooling circuit for cooling the flue gas and inorganic solvent in the inorganic solvent carbon dioxide capture section.

12. A method of carbon capture from a flue gas, comprising:
sequentially subjecting the flue gas to (a) organic solvent carbon dioxide capture, (b) water washing and (c) inorganic solvent carbon dioxide capture.

13. The method of claim 12, including using potassium hydroxide (KOH) as the inorganic solvent.

14. The method of claim 13, including spraying the KOH to produce KOH droplets having a Sauter mean diameter of less than 50 μm in the absorber column.

15. The method of claim 14, including using a mixture of a hindered primary amine and water as the organic solvent.

16. The method of claim 15, including regenerating the inorganic solvent in a polishing circuit including an electrochemical cell and a flash vessel whereby KHCO₃ and K₂CO₃ recovered from the absorber column are processed to release H₂ at the electrochemical cell, release O₂ and CO₂ at the flash vessel and regenerate KOH for return to the absorber column.

17. The method of claim 16, further including regenerating the organic solvent in a stripper whereby a carbon dioxide-rich organic solvent from the absorber column is processed in the stripper to release CO₂ and a carbon dioxide-lean organic solvent is returned to the absorber column.

18. The method of claim 17, further regenerating wash water in a water washing circuit adapted for removing entrained and aerosol organic solvent, and returning wash water to the absorber column.

19. The method of claim 18 including cooling the flue gas and inorganic solvent during carbon capture by the inorganic solvent.

20. The method of claim 19, further including maintaining the absorber column at an operating temperature between about 35° C. and 55° C. during carbon dioxide capture.
